(19) United States
(12) Patent Application Publication
(10) Pub. No.: US 2016/0040859 A1
(43) Pub. Date: Feb. 11, 2016

(54) LED Module, Luminaire Comprising Same And Method For Influencing A Light Spectrum

(71) Applicant: EATON PROTECTION SYSTEMS IP GMBH & CO. KGö, Schönefeld (DE)

(72) Inventors: Jens Burmeister, Eberbach (DE); Lisa Morr, Hirschhorn (DE)

(21) Appl. No.: 14/782,291

(22) PCT Filed: Apr. 2, 2014
(86) PCT No.: PCT/EP2014/000884

§ 371 Date: Oct. 2, 2015

(30) Foreign Application Priority Data
Apr. 5, 2013 (DE) 10 2013 005 934.8

(51) Int. Cl. F21V 19/00; H05B 33/08

(52) U.S. Cl. CPC F21V 19/001; H05B 33/0857; F21W 2131/103

(57) ABSTRACT

The invention relates to an LED module (1) for a luminaire (2) comprising at least one LED carrier (3) and a plurality of LEDs (4) (light-emitting diodes) arranged on this LED carrier. In particular, intensities of different-colored LEDs (4) are selected to emit a total light emission spectrum (6) being composed of individual light emission spectra (5) of each LED. The invention further relates to a luminaire (2) comprising a luminaire housing (10), at least one LED module (1) arranged as light source (13) in the luminaire housing (10), a light emergence opening (11) formed in the luminaire housing (10), and a glare-limiting device (12) assigned in particular to the light emergence opening (11), as well as to a method for influencing a light spectrum of a light source (13).

### PRIORITY CLAIM

The present application is a national phase of and claims priority to International Application No. PCT/EP2014/000884 with an International filing date of Apr. 2, 2014 and which claims priority to German patent application no. 10 2013 005 934.8 filed Apr. 5, 2013. The foregoing applications are hereby incorporated herein by reference.

### TECHNICAL FIELD

The invention relates to an LED module, a luminaire comprising such an LED module, and a method for influencing a light spectrum.

### BACKGROUND

A light spectrum, or also a color spectrum, is a part of the electromagnetic spectrum that can be perceived by the human eye without any technical aids. Such a light spectrum is composed of emitted or reflected spectral colors of one respective light source or of light sources. As a rule, such a light source emits light with a specific frequency spectrum or corresponding spectral distribution. The corresponding frequencies of the light determine the color thereof. Corresponding artificial light sources differ in color, brightness etc. A visible portion of the light spectrum has a wavelength in the range of approximately 380 to 780 nm, respectively frequencies in the range of approximately 3.8×10¹⁴ to 7.9×10¹⁴ Hz. Corresponding color components of the light spectrum are not distinguishable without optical aids. As a rule, many light sources emit a light spectrum that is a combination of different individual colors which, in the eye of a viewer, result in an overall color impression, respectively in a mixed color. Such a light color corresponds to a color impression of the light which directly stems from a corresponding luminous light source. The light color depends, in this case, on the spectral composition of this radiation.

With regard to the light color even a light being “white” per se can be subdivided, e.g. into warm white, neutral white, daylight white etc. Each of these corresponding shades of white has different effects on human beings. Corresponding psychological effects on the viewer are also discussed in connection with other light colors. In connection with other species it should furthermore be kept in mind that these normally have different sensitivities for specific spectral ranges as compared with human beings.

In connection with the light color yet another parameter should be considered, which is designated as the color rendering index.

This index is a photometric quantity by means of which the quality of the color rendering of light sources of the same correlated color temperature can be described. For instance, up to a color temperature of 5000 K, the light emitted by a black body of a corresponding color temperature serves as a reference for the evaluation of the rendering quality. The color rendering index is “100” if a corresponding artificial light source perfectly reproduces the spectrum of a black body with the same color temperature in the range of the visible wavelengths.

One example for light sources frequently used in the recent past are LED light sources which consume little energy and, at the same time, have a long lifespan. Corresponding LEDs normally generate a substantially monochromatic radiation. The shade of the corresponding LED light is dominated by the dominant wavelength of the corresponding radiation. LEDs are available in different colors, such as red, orange, yellow, green or blue. Also, white LEDs are known, which usually make use of a conversion layer in order to convert the LED-generated, actually blue light into white light. Such conversion layers are also known from fluorescent lamps.

A corresponding emission spectrum of an LED is relatively narrow-band, wherein—see the above statements—a corresponding dominant wavelength, and thus the color of the light depend on the materials used for the manufacture of a corresponding semiconductor crystal of the LED. Usually, LED light does not contain UV or IR radiation.

LEDs are preferably manufactured as LED modules. These modules are very flat and have a plurality of LEDs on one carrier. Such a carrier may also be flexible. The carrier may be a printed circuit board on which a corresponding wiring and/or electronic components are mounted for operating the LEDs.

In the DE 10 2010 033 141 document a luminaire is described, where the generated light is influenced with respect to spectral sensitivities of different species. The light source of such a luminaire is, for instance, an LED module, or a plurality thereof, as described above. In order to influence the corresponding light a filter device is used, which filters out one or more specific spectral ranges of the emitted light at least in part. Thus, spectral ranges are filtered out, or at least reduced, in which specific species, and in particular animals, have a greater sensitivity, and in which spectral ranges these species may be exposed to a negative influence. It is, of course, also conceivable that the spectral range of the light to be emitted is chosen to have a positive influence on one or more species. The corresponding luminaire may be used, for instance, as streetlight or for the illumination of sidewalks or parks, or the like.

Of course, it is also possible to realize a corresponding light filtering in rooms in which specific spectral ranges of the emitted light could trigger reactions or the like. See, for instance, biological, chemical or also physical applications.

According to the DE 10 2010 033 141 document a corresponding filter device is arranged in the luminaire housing or in the region of a light emergence opening of the luminaire housing. This means that influencing the corresponding light spectrum or color spectrum of the light source is achieved by an additional device. The drawback of such a device is that a portion of the light is retained, so that the effectiveness of the overall illumination system is reduced. In other words, filtering leads to a reduction of the radiation capacity or radiant intensity as compared to a luminaire without filtering with the same power supply.

### SUMMARY

Therefore, the invention is based on the object to allow influencing the light spectrum or color spectrum in an easy manner, without having to perform large-scale physical alterations or provide for additional installations in a corresponding luminaire. At the same time, only a small number of luminaires is used.

According to the invention the object is achieved by the features of patent claim 1. This applies analogously to the features of the method claim, and to a corresponding luminaire having such an LED module.

According to the invention the LED module is characterized in that the LEDs, in particular if the number and the color of the LEDs are predetermined, emit a total light emission spectrum being composed of individual light emission spectra of each LED, wherein the LEDs are variable relative to one another with regard to the intensities of their individual light emission spectra. This means that specific numbers of red, green, blue and/or yellow LEDs are used on the LED module, wherein each of these LEDs are adjustable with respect to their intensity so as to obtain the total light emission spectrum by varying the individual intensities of the corresponding light emission spectra and the subsequent superposition of these spetra.

The corresponding luminaire comprises at least one LED module, wherein also several of those modules are usable. Moreover, such a luminaire comprises at least one luminaire housing, a light emergence opening formed in the luminaire housing, and a glare-limiting device. This glare-limiting device limits the emergence of light from the light emergence opening of the luminaire to a specific range, for instance, for reducing a glare of the luminaire.

According to the method the corresponding light color of the light emitted by the luminaire is influenced in such a manner that a plurality of LEDs are arranged on a corresponding LED module at least in one row and/or column. Each of the LEDs emits light according to an individual light emission spectrum with a correspondingly adjusted intensity, wherein the individual spectra of all LEDs are superimposed to one total light emission spectrum, resulting in the light spectrum of the light source of the corresponding luminaire.

It is possible that each LED is configured to emit a substantially monochromatic light radiation. The corresponding individual light emission spectrum of each LED is known per se, or can at least be determined in advance. LEDs having a different monochromatic light radiation are then arranged together on the corresponding LED carrier, and by the superposition of the individual light emission spectra each with a respective intensity to one total light emission spectrum the correspondingly desired light spectrum of the light source is obtained.

It is possible that LEDs having the same monochromatic light radiation are respectively arranged on a sub-module of the LED module. This means that LEDs having the same monochromatic light radiation are each arranged together, and sub-modules with those LEDs are combined depending on the required number of the corresponding LEDs. In this case, the LEDs are arranged relatively closely to one another, so that already a small distance is enough, and with the aid of corresponding reflection devices, if necessary, that point light sources are no longer discernible, but only the superposition of all individual light emission spectra to the total light emission spectrum can still be recognized by a viewer.

By using sub-modules it is possible in a simple way to combine LEDs with a corresponding light color according to need, and choose a respective number. If, for instance, more yellow LEDs are required, more sub-modules with those yellow LEDs are added. This applies analogously to LEDs with different colors.

It is also possible, however, that LEDs having a different monochromatic light radiation are arranged on a sub-module of the LED module. This means that a desired light color is already provided on a sub-module by combining differently colored LEDs each with a corresponding intensity on this sub-module. A number of such sub-modules can then be used together as an LED module, and these then bring about the desired total light emission spectrum.

The LED arrangement is such that the LEDs are arranged on the corresponding LED carrier along at least one row and/or column. As was already stated above, such a carrier may be a corresponding printed circuit board for supplying the LEDs, for the corresponding wiring for necessary connections, and also for the arrangement of other electronic or electrical devices.

With a row and/or column arrangement of this type it is possible that, for instance, only same-colored LEDs are arranged along one row or, correspondingly, that those LEDs are arranged along one column. Also, it is conceivable that different-colored LEDs are provided in each row and/or column.

According to the invention it is particularly advantageous in this connection if each LED can be triggered individually, i.e. is supplied in particular with a corresponding voltage, respectively current intensity. Thus, all LEDs are reliably controlled, and the correspondingly emitted individual light emission spectrum is well reproducible with its corresponding intensity, and the total light emission spectrum is reliably producible by adding up all individual light emission spectra. Also, it is possible that all same-colored LEDs are correspondingly supplied with a selected voltage, respectively current.

In order to increase, if necessary, the color rendering index of the corresponding light source white LEDs may be assigned to the monochromatic LEDs. The number of the white LEDs can be determined, for instance, in that the color rendering index is to reach a value of 100 or at least close to 100.

In order to be able to change the total light emission spectrum in an easy manner, if necessary, it is conceivable that modules and/or sub-modules are arranged in the luminaire to be exchangeable. This may analogously be applied to the corresponding LED carrier.

In order to change the light color of the light source for a short time, if necessary, it may furthermore prove to be advantageous if the sub-modules can be triggered individually. This means that, for instance, a sub-module with only yellow LEDs is switched on only if the total light emission spectrum is to be changed correspondingly by switching on these yellow LEDs. This applies analogously to different-colored LEDs, white LEDs and the like.

As was already stated above, such an adjustment of the total light emission spectrum can be made particularly with respect to specific species that have a greater sensitivity in a spectral range. Also, it is conceivable that the adjustment of the total light emission spectrum is made with respect to more than one species, if these have the same sensitivity in a specific spectral range or at least in closely adjacent spectral ranges. According to the invention it is also possible to intensify a specific spectral range with respect to light emission by switching on LEDs, if the LEDs to be switched on irradiate, for instance, in this spectral range. Thus, certain advantageous effects in the specific spectral range may be enhanced.

It is likewise possible that the light spectrum is not only changed by switching on corresponding LEDs, but also by the selective deactivation of specific LEDs having a known individual light emission spectrum. Such a deactivation of LEDs and, if necessary, the variation of intensities of the remaining LEDs, too, results in a change of the total light emission spectrum which may have the desired effect.

### BRIEF DESCRIPTION OF THE DRAWINGS

Advantageous embodiments will be described in more detail below by means of the figures depicted in the drawing. In the drawing:

FIG. 1 shows a perspective bottom view of a luminaire having LED modules;

FIG. 2 shows an enlarged representation of an exemplary embodiment of an LED module;

FIG. 3 shows an enlarged representation of another exemplary embodiment of an LED module;

FIG. 4 shows individual light emission spectra of different intensities for different-colored LEDs;

FIG. 5 shows a total light emission spectrum formed of the individual light emission spectra represented in FIG. 4;

FIG. 6 shows another example analogously to FIG. 4, and

FIG. 7 shows a total light emission spectrum formed of individual light emission spectra of FIG. 6.

### DETAILED DESCRIPTION OF EXAMPLE EMBODIMENTS

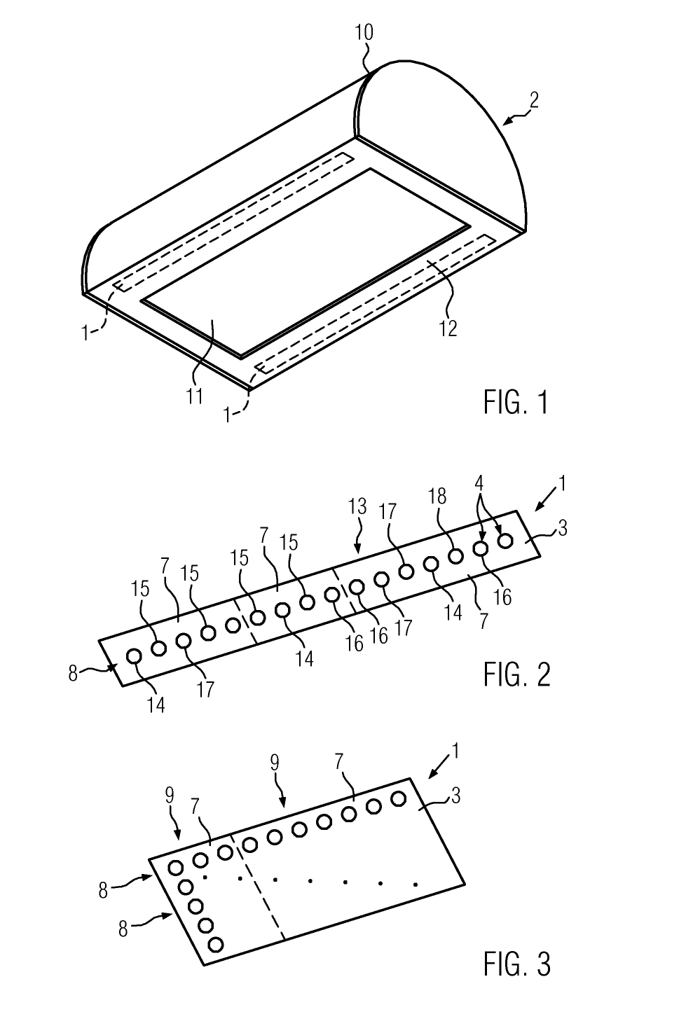

FIG. 1 shows a perspective diagonal bottom view of a luminaire 2 comprising an LED module 1 according to the invention. In the illustrated embodiment corresponding LED modules 1 are arranged as light source 13 on both sides of a light emergence opening 11 in a luminaire housing 10. The LED modules 1 can both be triggered at the same time and supplied with voltage, respectively current. The luminaire 2 as illustrated is only an example and shown in a simplified manner, and may be used, for instance, for the illumination of paths, roads and the like. In order to prevent, or at least reduce a possibly existing glare of the corresponding lamp inside the luminaire 2 a glare-limiting device 12 may be assigned to the light emergence opening 11, which reduces, for instance, the light emergence opening 11 in the direction of the surface to be irradiated and, if necessary, limits light additionally emitted by the light source only to a certain area for the illumination thereof.

Different embodiments for a corresponding LED module 1 are conceivable. Two embodiments are shown in FIGS. 2 and 3.

In the embodiment according to FIG. 2 corresponding LEDs 4 are arranged along a row 8. The LEDs 4 are all arranged on an LED carrier 3 which is configured, for instance, as a printed circuit board. The LED carrier 3 with the LEDs 4 of FIG. 2, or also of FIG. 3, forms a corresponding LED module 1. It is once more pointed out that, for instance, the arrangement and number of the LEDs 4 on the corresponding LED carrier 3 are only exemplary, and are shown with a small number of LEDs 4. It is also possible to use more LED carriers 3, respectively LED modules 1 in the luminaire 2 according to FIG. 1.

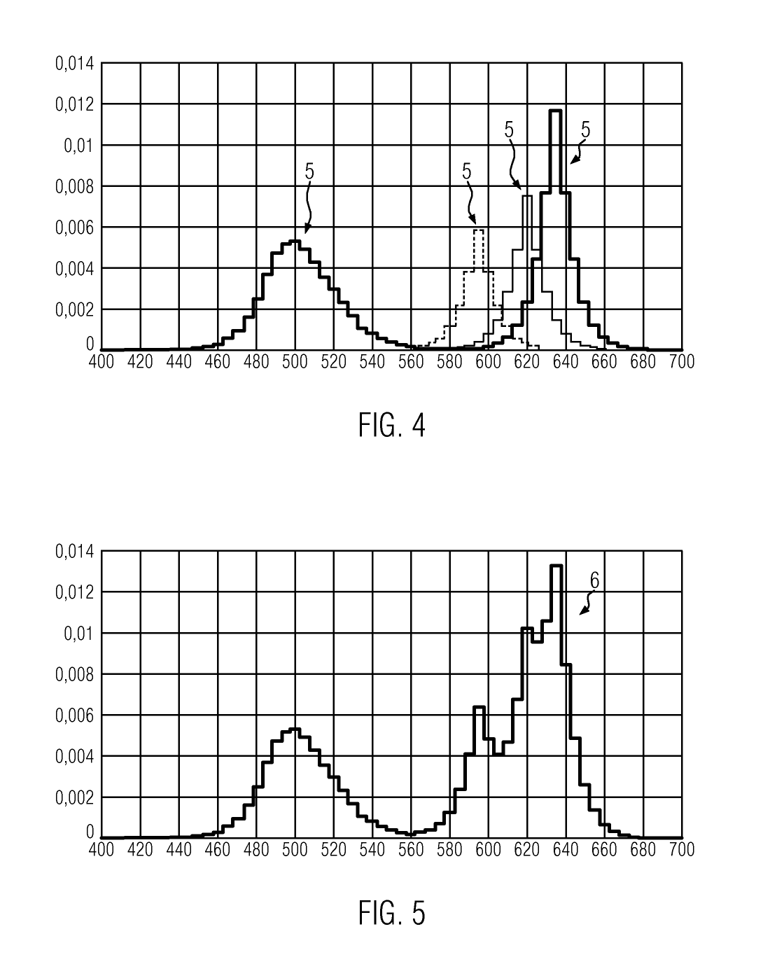

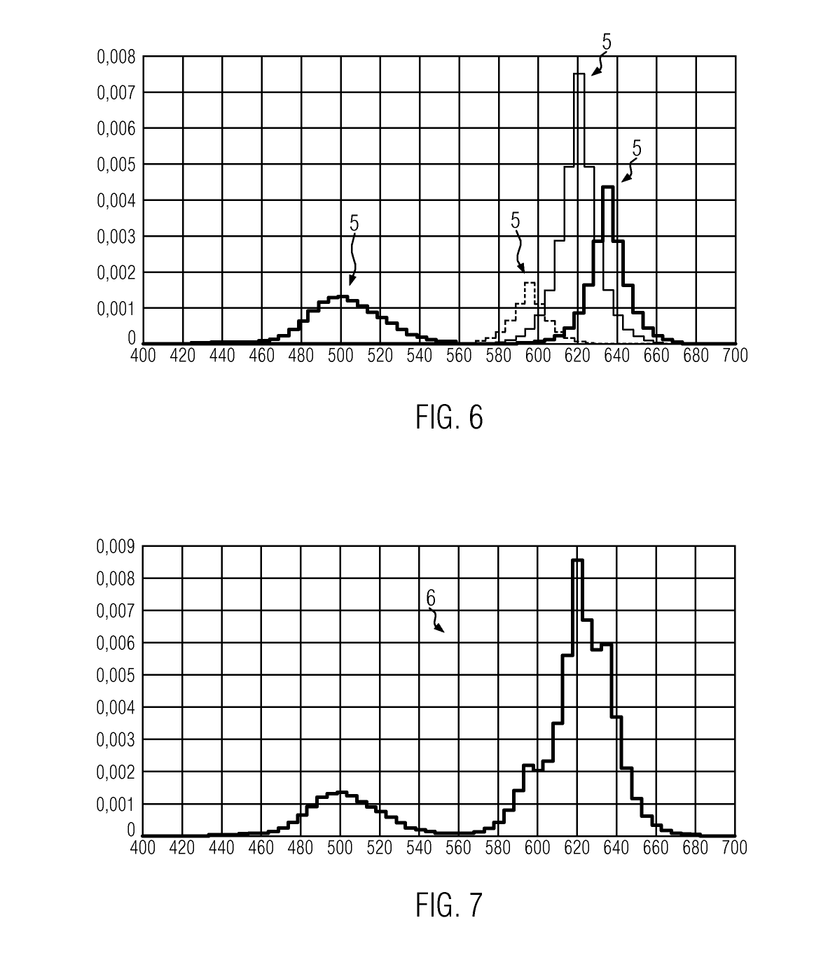

The different LEDs 4 on the carrier 3 are different-colored LEDs and have, depending on the color, another individual light emission spectrum. See also FIGS. 4 and 6. LEDs are substantially monochromatic light sources, i.e. they emit light only in a narrow-band, respectively limited spectral range. By deliberately choosing the corresponding semiconductor materials and the doping thereof it is possible to vary the properties of the light generated by LEDs. Nowadays, LEDs having red, orange, yellow, green, blue and violet colors are available. Radiation by LEDs can also be produced beyond this visible range of the light spectrum. See, for instance, the near-infrared range up to a wavelength of 1000 nm or also the ultraviolet range.

For generating white light by a light-emitting diode, for instance, a blue or UV LED is used, with additional photoluminescent material. Similar to fluorescent tubes this material converts the short-wave and higher energetic light into longer-wave light.

A corresponding number of individual LEDs 4 of different colors are arranged on the LED module 1, respectively LED carrier 3. See, for instance, green LEDs 14, yellow LEDs 15, orange LEDs 16, red LEDs 17 or white LEDs 18.

It is noted once more that the arrangement and number of the LEDs are only exemplary.

This applies analogously to FIG. 3, in which the corresponding LEDs 4 are arranged both in rows and columns. In the embodiment shown five rows and ten columns of LEDs are provided on the corresponding LED carrier 3, respectively LED module 1.

In this module according to FIG. 3, too, different-colored LEDs can be arranged both along a row and a column.

Also, it is possible that a corresponding LED module 1, respectively LED carrier 3, is composed of sub-modules 7. These may have, for instance, a respectively predefined number of different-colored LEDs, or also be provided with only monochromatic LEDs. This applies analogously to the embodiment of FIG. 3.

According to the invention it has proved to be advantageous that the LEDs 4 on the corresponding carrier, respectively corresponding module, are triggered differently, i.e. are supplied individually with voltage, respectively current. By this, the light emission of each LED is predetermined with respect to its individual light emission spectrum, and well known, without great effort, so that the different individual light emission spectra can be superimposed to one total light emission spectrum. See the statements set forth below. It is also possible, however, that the sub-modules are triggered separately. This is particularly favorable if each sub-module is occupied, for instance, by LEDs of only one color. This means that, for instance, all yellow LEDs arranged on a specific sub-module 7 could be switched off or switched on or changed in terms of their intensity. Thus, a corresponding individual light emission spectrum for the light color “yellow” would be missing in the total light emission spectrum, or at least be changed in its intensity. Moreover, it is possible to provide several sub-modules each with same-colored LEDs so that, for instance, one sub-module with yellow LEDs, two of those sub-modules, or also more of them can be switched on/off or varied with respect to their intensity. This applies analogously to different-colored LEDs.

The above statements also apply if different-colored LEDs are provided on each sub-module, so that, depending on the case of need, fewer or more of such sub-modules are arranged together in a luminaire, or are triggered in a luminaire, to obtain the corresponding illumination.

FIG. 4 illustrates an embodiment for an LED module 1 having a number of individual light emission spectra 5. FIG. 4 firstly shows from left to right an individual light emission spectrum for the color green, for the color yellow, for the color orange, and for the color red. The intensities of the corresponding spectra are indicated in nm, depending on the wavelength. For instance, the intensities for the green, red and orange LEDs are equal and substantially three times greater than those of the yellow LEDs. If one is positioned sufficiently apart from the corresponding light source 13, respectively luminaire 2, the individual light emission spectra are superimposed to one total light emission spectrum 6. See FIG. 5 in which no LEDs 4, see FIGS. 2, respectively 3, are discernible any longer as individual light sources. That is, FIG. 5 shows a mixture of four different LED types with different light colors which, moreover, may be provided in different numbers. A corresponding total light emission spectrum 6 can already be composed of the individual light emission spectra known per se relatively well prior to setting up the lamp by a corresponding computer simulation or the like. That is, it is possible to realize a corresponding total light emission spectrum for predetermined illumination purposes in a corresponding luminaire in a targeted manner.

FIGS. 6 and 7 show another exemplary embodiment. Again, corresponding individual light emission spectra 5 for green, yellow, orange and red LEDs are shown from left to right in FIG. 6. In this case, the corresponding LEDs are operated at specific percentages of their normal intensity. For instance, the intensity of the red LED is 37.5%, of the green LED 25%, of the orange LED 100% and of the yellow LED 87.5% of the original or normal operating intensity. In this embodiment the relative portion of “green” is reduced in comparison with FIG. 5.

This means, for a species reacting sensitively, for instance, in the green range a light source having a total light emission spectrum 6 according to FIG. 7 would be advantageous. Vice versa, a light source having a total light emission spectrum 6 according to FIG. 5 could be used if value is placed on an increased portion in the green range.

The other portions of the total light emission spectrum according to FIGS. 5 and 7 are nearly unchanged.

By correspondingly selecting the number, the color and, in particular, the variation of the intensities of the different LEDs of a sub-module 7, respectively the entire LED module 1, it is possible to realize yet other total light emission spectra 6, as desired and needed.

In connection with FIG. 2 a white LED 18 was emphasized which may be provided in addition to the colored LEDs, for instance, in order to increase the color rendering index. Of course, it is also possible in this connection to use more of those white LEDs.

As was explained above the present invention yields the advantage that a controlled mixing of light is possible even with a relatively small number of LEDs by using different intensities of the respectively applied LEDs. It is not necessary, for example, to change the total light emission spectrum by switching on or off corresponding LEDs having a predefined color. This means, the present invention permits a corresponding spectral distribution with a small number of LEDs. This is advantageous, for instance, if small lamps are used which only have little space for the arrangement of LEDs.

It is also possible, however, that in addition to varying the intensities of the individual LEDs, or at least the same-colored LEDs, a corresponding variation of the number and/or color of the LEDs is made, too, in addition to the intensity variation.

1. A light emitting diode (“LED”) module (1) for a luminaire (2) comprising at least one LED carrier (3) and a plurality of LEDs (4) arranged on this LED carrier, in particular of a predetermined number and color, which are variable relative to one another with regard to the intensities of their individual light emission spectra to emit a total light emission spectrum (6) being composed of individual light emission spectra (5).

2. The LED module according to claim 1, characterized in that each LED (4) is configured to emit substantially monochromatic radiation.

3. The LED module according to claim 1, characterized in that LEDs having the same monochromatic light radiation are each arranged on a sub-module (7) of the LED module (1).

4. The LED module according to claim 1, characterized in that LEDs having different monochromatic light radiation are each arranged on a sub-module (7) of the LED module (1).

5. The LED module according to claim 1, characterized in that LEDs can be arranged on the LED carrier (3) along at least one row (8) and/or a column (9).

6. The LED module according to claim 1, characterized in that all LEDs can be triggered separately.

7. The LED module according to claim 1, characterized in that white LEDs are assigned to the monochromatic LEDs in order to increase a color rendering index.

8. The LED module according to claim 1, characterized in that the LED modules and/or sub-modules can be arranged in the luminaire to be exchangeable.

9. The LED module according to claim 1, characterized in that the sub-modules (7) can be triggered individually.

10. The LED module according to claim 1, wherein the luminaire (2) comprises a luminaire housing (10), at least one of the LED module (1) is arranged as a light source (13) in the luminaire housing (10), the luminaire housing comprising a light emergence opening (11) formed in the luminaire housing (10), and a glare-limiting device (12) assigned in particular to the light emergence opening (11).

11. The LED module according to claim 10, wherein a total light emission spectrum of the luminaire is substantially free from spectral ranges in which at least one specific species, in particular animal species, has a greater sensitivity as compared to other species.

12. The LED module according to claim 10, wherein the luminaire (2) can be applied as a path luminaire or road luminaire.

13. A method for influencing a light spectrum of a light source (13), which light source is formed of a plurality of individual LEDs arranged on an LED module (1) particularly in rows (8) and/or columns (9), wherein individual emission spectra of the individual LEDs, in particular if the number and the color of the individual LEDs are predetermined, are superimposed with a variable intensity to one total light emission spectrum as the light spectrum of the light source.

14. The method according to claim 13, characterized by simultaneously and separately triggering all individual LEDs.

15. The method according to claim 13, characterized by individually triggering the individual LEDs on a sub-module (7) for selecting the number of individual LEDs of a specific color.

16. The method according to claim 13, characterized by triggering a number of white LEDs in addition to the triggered colored LEDs.
